(19) United States
(12) Patent Application Publication
(10) Pub. No.: US 2025/0196028 A1
(43) Pub. Date: Jun. 19, 2025

(54) HEREWITH FILTER ELEMENT AND FILTER MODULE

(71) Applicant: FAUDI Aviation GmbH, Stadtallendorf (DE)

(72) Inventors: Uwe LAUBER, Linden/Leihgestern (DE); Volker SCHLEPPHORST, Braunweiler (DE)

(73) Assignee: FAUDI Aviation GmbH, Stadtallendorf (DE)

(21) Appl. No.: 18/980,229

(22) Filed: Dec. 13, 2024

(30) Foreign Application Priority Data
Dec. 15, 2023 (EP) 23217024.1

(51) Int. Cl. B01D 29/15; B01D 29/90; B01D 29/92

(52) U.S. Cl. CPC B01D 29/15; B01D 29/90; B01D 29/92; B01D 2201/02; B01D 2201/043; B01D 2201/291

(57) ABSTRACT

The invention relates to a filter element (1) with one filter tube (10), which has a cavity (11) and a first and a second end (12, 13), wherein an access (20) into the cavity (11) with an access channel (21) is formed at the first end (12) of the filter tube (10). The access channel (21) is designed as a Venturi tube (22) with a cross-sectional constriction (23).

The invention refers to a filter element according to the general term of claim 1 and a filter module therewith in accordance with claim 15.

Filter elements and filter modules are used to extract solid or liquid components from a filter medium. Filter elements designed as coalescers and/or separators, for example, are used to separate a first liquid from a second liquid. For example, filter elements are known that are configured as water-fuel separators in order to separate water from fuel or vice versa.

Coalescer elements (also known as coalescer elements) are used in the first stage of a filter/water separator (a filter module), for example, when fuel enters a tank. The flow through the coalescer element is from the inside to the outside. For this purpose, they have a filter tube made of a material that is more difficult to penetrate for the medium to be separated than for the medium to be cleaned. This results in the formation of larger droplets of the medium to be separated inside the filter tube or on its surface, which sink or rise due to their size and a difference in density to the medium to be cleaned and can be collected in a designated collection chamber. This collection chamber can then be emptied.

For example, separator elements are used as an effective water barrier as a second stage in filter/water separators. After exiting the coalescer element, the exemplary fuel can pass through the surface of the separator element, whereas water droplets are repelled by the hydrophobic separator surface and run off on the outer surface of the separator element. This separated water then also enters the collection chamber.

DE 19 05 190 A, for example, describes a filter device or filter module in which tubular first and second filter elements are arranged parallel to each other in a filter container. The water is fed into the filter container through the first filter elements and drained out of the container via the second filter elements. The second filter element is described as a clarifier for water separation. It is possible for the first filter element to be designed as a coating element.

It is known from DE 38 18 595 A1 that a filter tube for a Coalescer element can be manufactured in that a perforated support tube or perforated support body forms a winding core for glass fiber mats of different porosities or glass fiber reinforced polyamide mats, so that the support tube and the mats wound in several layers on the support tube make up the filter tube. The support tube is then closed at its ends with a first end plate, which forms an access port, and a sealing second end plate. The coalescer element is now used to introduce hydrocarbon containing free water through the access into the support tube and to transport it from the inside to the outside through the filter tube. A similar method of wrapping a support core with a mat-shaped glass fiber material to form a filter or coalescer element is also described in DE 21 26 080 C3 and DE 11 13 783 B.

A separator element can be designed in the same way, but the filter materials of the filter tube must be selected differently in order to achieve water separation on the inlet side or directly at the inlet surface.

The disadvantage of these designs is that the pressure decreases over the length of the filter tube, so that the amount of fluid passing through the filter tube decreases with the increasing distance from the inlet. The slimmer and longer the filter tube is, the more pronounced the problem becomes, especially as the cross-sectional area of the inlet formed at the end face of the end plate is then also small. With solid filters, it can be observed that the filter elements in the area of the inlet opening become soiled more quickly than those further away. However, for a good filter result over the service life, a uniform clogging is preferable. With filter elements that work according to the coalescence principle (coalescer elements), the flow rate through the filter tube in the area of the inlet must not be so high that droplets of the separated medium are split up again by the main medium and carried away instead of running off. The entire filter element must then be operated with the passage velocity limitation present in the access area. At a distance from the inlet, the air then flows through the filter tube at a speed that is lower than would actually be possible for separation. With separator elements, the effect can be observed in the opposite direction of flow. More first fluid passes through the filter tube in the area of the inlet and a correspondingly larger amount of the second fluid must be retained per time than at a distance from the inlet.

A further disadvantage is that the filter elements, separator elements or coalescer elements are replaceable parts and are inserted in the filter container in receiving openings. There is at least one seal in a sealing gap. Microbial growth can occur here due to a lack of flow. This is particularly critical on the clean side of the filter element because the microbes can be discharged from the filter device or filter module with the cleaned fluid, often in the form of small clumps. However, the microbes and clumps can also come loose when the filter elements are replaced. They can then fall into the filter container, for example, and contaminate the new filter elements as soon as they are recommissioned. Microbes that remain in a receptacle of a filtration element, in particular a separator element, can be pushed into the clean-side outlet of the filter module when the new filter element is inserted. The microbes can then settle elsewhere and the small clumps can clog fuel filters upstream of a drive, for example.

The task of the invention is therefore to overcome the disadvantages of the prior art and to provide a solution which leads to a low-cost, easy-to-manufacture and environmentally friendly filter element, in particular also separator element and/or coalescer element, whereby easy maintenance and disposal is also desired.

Main features of the invention are given in the characterizing part of claim 1 and in claim 15. Arrangements are the subject of claims 2 to 14 and the specification.

The invention relates to a filter element with a filter tube which has a cavity and a first and a second end, with an access into the cavity with an access channel being formed at the first end of the filter tube. It is preferable that the access channel is designed as a Venturi tube with a narrowed cross-section.

The advantage of this is that a lower drop in pressure can be achieved across the access channel compared to a purely cylindrical access channel. This allows a high flow rate to be achieved even with thin filter tube diameters. In particular, the diameter of the access channel at the free end can be larger than the internal diameter of the cavity. In addition, higher flow velocities are achieved in the center of the cross-sectional constriction than further out, so that the pressure difference over the length of the filter tube is lower.

According to a more detailed embodiment, it is provided that the cross-sectional constriction has a conical taper in the direction of the cavity; and/or the cross-sectional constriction has a conical widening in the direction of the cavity, in particular on the side of the conical taper facing the cavity. These cones make it easy to taper the cross-section of the Venturi tube.

In particular, the conical taper can have an angle of 4 to 15 degrees, preferably 6 to 11 and particularly preferably 7 to 9 degrees to the cone axis (this angle therefore corresponds to half the opening angle of a rotationally symmetrical cone). Furthermore, the conical widening can have an angle of 4 to 15 degrees, preferably 6 to 11 and particularly preferably 7 to 9 degrees to the cone axis (this angle therefore corresponds to half the opening angle of a rotationally symmetrical cone).

In terms of flow technology, it is favorable if the conical taper has a greater axial length than the conical widening. This allows the suction to be generated harmoniously during outflow due to the slower change in cross-section, particularly in the case of filter elements designed as separators.

In an optional embodiment, it is provided that the cross-sectional constriction has an (at least essentially) cylindrical channel section in the area of the smallest internal dimension. This will prevent flow separating from the wall of the access channel because the flow deflection from the narrowing to the widening is slower.

A design is possible in which the conical expansion has a smaller axial length than the cylindrical channel section. The conical taper should have a greater axial length than the cylindrical channel section. Furthermore, the cross-sectional constriction in the area of the smallest internal diameter should have a cross-sectional area that is smaller than the cross- sectional area of the cavity.

In a particular embodiment, the access channel has a cylindrical end section on the side facing the filter tube. which protrudes into the filter tube in particular. This creates a transition with laminar flow to the filter tube.

Preferably, the cavity is cylindrical. The filter tube is also preferably cylindrical. As a result, the flow velocity is as harmonious as possible without dead flow areas and a space-saving adjacent arrangement of several such filter elements is possible.

The flow effects of the Venturi tube are particularly effective if the cavity between the first and second ends has a length that is at least four times, preferably at lease seven times and particularly preferably at least ten times as great as the width of the cavity in the cross direction for this purpose.

In principle, it is possible for the access channel to be formed in one piece with at least one layer of the filter tube, preferably in one piece with a support tube of the filter tube.

However, a preferred embodiment is one in which the access channel is formed in an end piece that is connected to the filter tube. This allows the end piece to be made of plastic, for example. Any support tube for the filter tube can then be made from a different material, e.g. a different plastic, a fiber composite material or metal.

In terms of flow technology, a design is suitable in which the access channel in the end piece at the end facing the filter tube has a diameter that is smaller than a diameter at the end facing away from the filter tube.

Optionally, the access channel in the end piece at the end facing the filter tube can have a diameter that is smaller than the diameter of the cavity. This keeps the laminar flow away from the inner wall of the filter tube. The end piece can also be designed in such a way that it can be pushed into the filter tube. This allows a stable connection to be formed.

In a particular embodiment, the end piece has a receiving groove on the side facing the filter tube, into which the filter tube is inserted axially. This creates a stable connection. The filter tube can be secured in the mounting groove, in particular in a fluid-tight manner, and preferably by gluing, casting, press-fitting or welding in.

Preferably, the filter tube has a layered structure with a support tube and at least one filter material. This means that the support tube can be configured for the task of support or dimensional stability and you are free to choose the material for the actual filter material, which in particular does not have to be dimensionally stable.

The support tube is preferably a sieve tube.

In a coalescer design, the layer structure can be coalescing. Preferably, at least one filter material of the layer structure is hydrophobic. Optionally, at least one filter material of the layer structure can be hydrophilic.

In the preferred design as a separator, at least one filter material of the layered structure can be a separator fabric, in particular the outermost layer. This can be made hydrophobic, for example, in order to separate water from fuel. Optionally, at least one filter material of the layered structure can be a scrim. Preferably, the separator fabric surrounds the scrim, whereby the separator fabric should have finer openings than the scrim. The scrim supports e.g. the finer-meshed separator fabric from larger openings in the support tube. In addition, the scrim can form flow channels between the openings in the support tube so that the fluid finds its way to the openings in the support tube, even if it has penetrated the separator fabric in an intermediate area between such openings, for example.

In a particular embodiment, a tubular plug-in coupling section with an outer circumference and a free end for axial insertion into a mounting opening is formed in the region of the access, wherein the plug-in coupling section is preferably formed by the optional end piece, wherein at least two radial passage openings are formed in the plug-in coupling section, which are arranged in at least two planes axially offset from one another, and which each connect a radial environment around the outer circumference to the access channel. When the plug-in coupling section is inserted into the assembly opening, an assembly gap results, primarily due to defined sealing surfaces adjacent to these. The pressure gradient in the access channel, especially if there is a change in cross-section between the levels, e.g. If the access channel is designed as a Venturi tube, a continuous flushing flow is generated between the two axially offset openings, which keeps the installation gap clean. A kind of bypass is formed between the axially offset openings. The cross-section of the access channel should preferably be of different sizes in the offset levels.

In particular, at least six radial passage openings can be formed in the plug-in coupling section, which are arranged in at least two axially offset planes and which each connect a radial environment around the outer circumference to the access channel. This allows the flushing flow to be positioned in the annular mounting gap where it is required.

Preferably, the radial openings are distributed around the circumference of the plug-in coupling section, and preferably evenly distributed. This allows the entire annular assembly gap to be flushed evenly with the flushing flow.

Furthermore, (exactly) one, (exactly) two or at least two sealing grooves for one sealing ring each can be formed in the outer circumference of the plug-in coupling section, the passage openings being arranged between the free end of the plug-in coupling section and that of the sealing grooves which is arranged furthest away from the free end. This means that the flushing flow cannot pick up any fluid that is present on the outside of the filter tube or filter element. The optional multiple sealing rings are usually used to achieve a stable mounting of elongated filter elements and thus prevent seal deformation and leaks due to bending moments, for example. If the sealing ring located furthest away from the free end seals sufficiently, the assembly gap can be flushed from this sealing level to the free end and thus remains free of microbes and deposits.

According to a more detailed embodiment, at least two sealing grooves can be provided and the through-openings are arranged between the two sealing grooves. The through-openings make it possible to continuously flush even the intermediate sealing space between two seals.

In terms of flow, it is favorable if the cross-sectional area of the respective passage opening is smaller than one percent of the smallest cross-sectional area of the access channel, in particular the Venturi tube. This means that the main flow continues through the access channel and only a small flushing flow is generated in the installation gap. In addition, vortices are reduced at the transitions between the access channel and the passage openings.

Preferably, the through-holes are arranged in the conical taper. They are therefore positioned away from the filter tube and in an area with a large pressure difference.

The conical taper of the cross-sectional narrowing preferably leads to the free end of the plug-in coupling section. This reduces a cross-sectional jump to the assembly opening and the minimum wall thickness of the plug-in coupling section can be limited to the free end.

The plug-in coupling section can have a cylindrical outer wall that forms at least part of the outer perimeter of the plug-in coupling section. This results in a slim, tubular design, even in the area of the plug-in coupling section.

Furthermore, the insertion coupling section can have an insertion stop, preferably in the form of a circumferential rib. This allows the installation depth in the installation opening to be defined and controlled.

It is advantageous if the plug-in coupling section has an insertion slope on the side facing away from the filter tube. This makes it easy to insert into a mounting opening.

The second end of the filter tube should be closed, preferably with a sealing piece (also known as an end plate). However, it is also possible, for example, to implement a closed end formed in one piece with a support tube.

The invention also relates to a filter module with a filter housing which forms a housing cavity with a filter inlet and a filter outlet, and with at least one filter element as indicated above and below in the housing cavity, wherein the filter inlet or the filter outlet opens into the access opening of the filter element and is thereby flow-connected to the housing cavity via the filter element, in particular also its filter tube. The preferred design of the filter element with access channel as a Venturi tube improves the flow through the filter module and the cleaning efficiency of the fluid to be cleaned. The optional plug-in coupling section and through openings can be used to generate a flushing flow to prevent microbial formation.

Optionally, the housing cavity has a fluid sump for a separated fluid. This allows separated external fluid to be separated.

Preferably, the filter element is designed as a separator element and its access opening opens into the filter drain. Optionally, a further filter device can be designed as a coalescer element, the access opening of which opens into the filter inlet.

Further features, details and advantages of the invention are apparent from the wording of the claims and from the following description of embodiments with reference to the drawings. It shows:

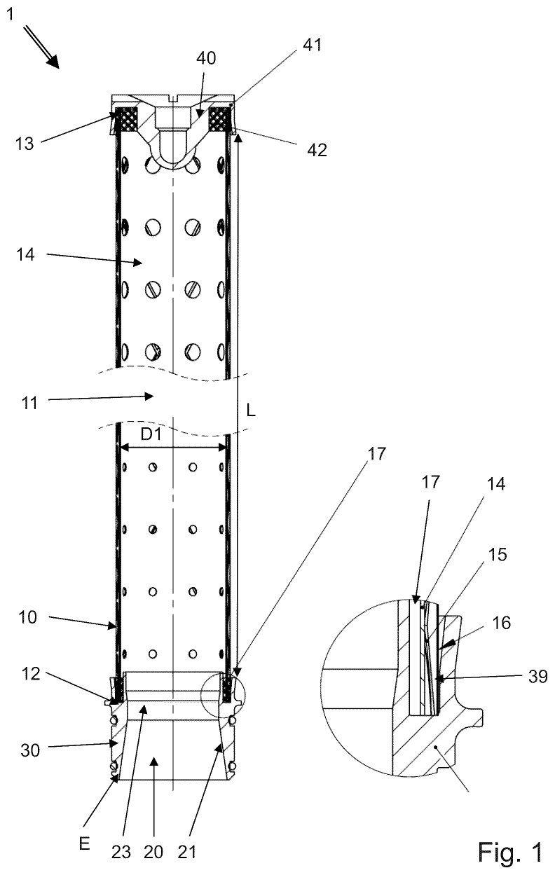

FIG. 1 a longitudinal section through a filter element with an enlarged view;

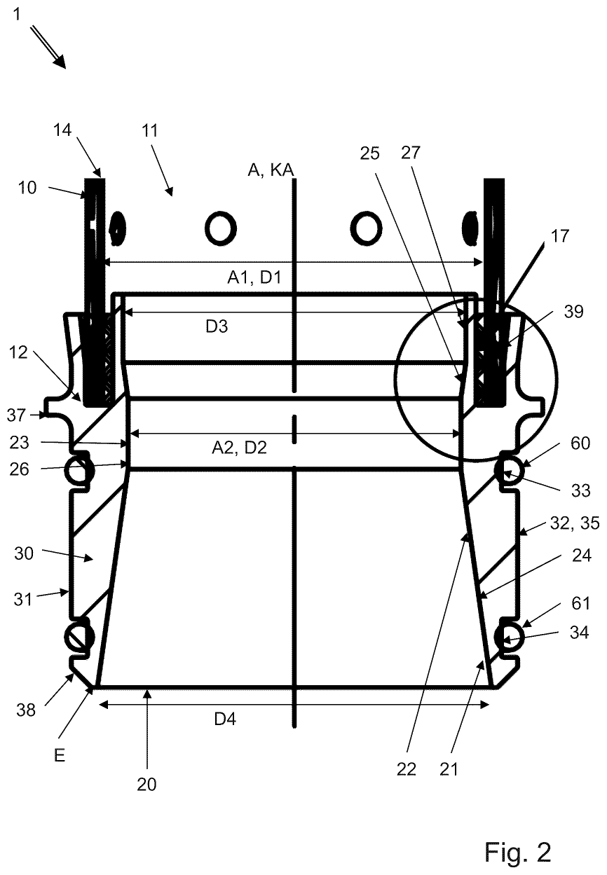

FIG. 2 an enlarged section of the filter element in the area of an end piece according to FIG. 1;

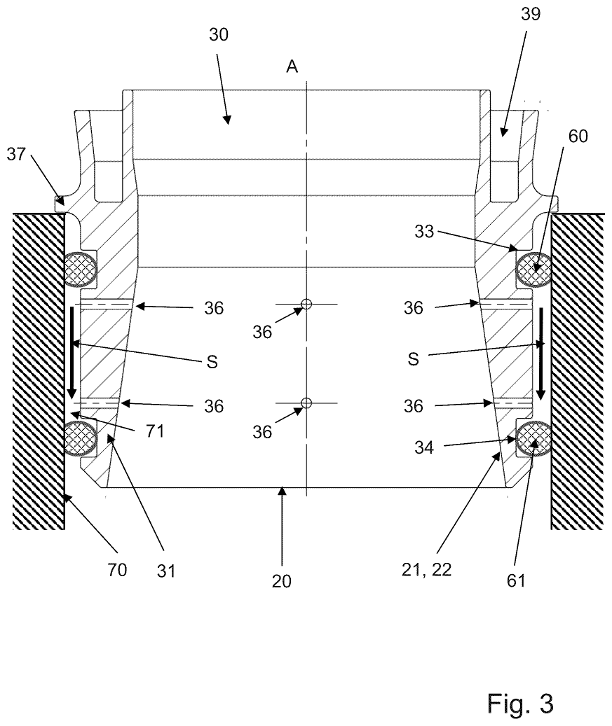

FIG. 3 a detailed view of an end piece of a filter cartridge in an assembly opening as a longitudinal section; and

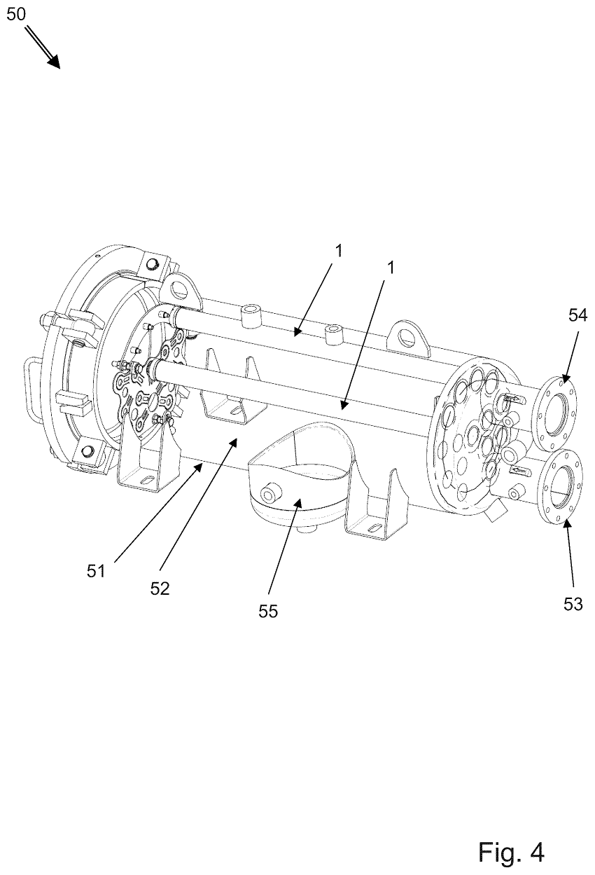

FIG. 4 a perspectival view of a filter module with components shown partially transparent.

FIG. 1 shows a filter element 1 which has a tubular filter tube 10. The filter tube 10 forms a cylindrical cavity 11 and has a first and a second end 12, 13. The cavity 11 formed by the filter tube 10 between the first and second ends 12, 13 has a length L that is at least four times as great as a width or a diameter D1 of the cavity 11 in the transverse direction thereto.

According to the magnified section of FIG. 1, the filter tube 10 has a layered structure with a support tube 14, in particular a sieve tube, and at least one filter material 15, 16. The filter material 15 can, for example, be a mesh fabric that is surrounded by the filter material 16. The filter material 16 can be a separator fabric. In this case, the filter element 1 is a separator, e.g. for separating water from fuel. Alternatively, however, a coalescing layer structure is also possible. Dann kann beispielsweise wenigstens ein Filtermaterial 15 des Schichtaufbaus hydrophob und ein Filtermaterial 16 des Schichtaufbaus hydrophil ausgebildet sein.

At the first end 12 of the filter tube 10, an access 20 into the cavity 11 is formed with an access channel 21. This access channel 21 is designed as a Venturi tube 22 with a cross-sectional constriction 23. This area of the venturi tube 22 is described in more detail later in FIG. 2. In the present case, the access channel 21 is formed in an end piece 30, which is connected to the filter tube 10. The second end 13 of the filter tube 10 is closed, namely with a closure piece 40.

As can be seen in the enlarged section of FIG. 1, the end piece 30 has a receiving groove 39 on the side facing the filter tube 10, into which the filter tube 10 is inserted axially, in this case with the support tube 14 and the filter material 15, 16. The filter tube 10 is secured there in a fluid-tight manner by a casting compound 17.

On the side facing the filter tube 10, the sealing piece 40 also has an end-face receiving groove 41, into which the filter tube 10 is inserted axially, in this case with the support tube 14 and the filter material 15, 16. There, the filter tube 10 is secured in a fluid-tight manner by a casting compound 42.

FIG. 2 shows an enlarged section of the filter element 1 according to FIG. 1 in the area of the end piece 30. Therefore, the same reference numbers refer to the same technical features. For this reason, reference is made to the description of FIG. 1 and only the further technical details of the end piece 30 are explained.

The access channel 21 in the end piece 30 is designed as a Venturi tube 22 with a cross-sectional constriction 23. In addition, the cross-sectional constriction 23 has a conical taper 24 in the direction of the cavity 11 and a conical widening 25 in the direction of the cavity 11, namely on the side of the conical taper 24 facing the cavity 11.

The conical taper 24 has an angle of between 4 and 15 degrees, in particular an angle of 8 degrees, to a cone axis KA, which is aligned coaxially to the axis A of the filter element 1, in particular also of the filter tube 10 and the end piece 30. The conical widening 25 also has an angle of between 4 and 15 degrees to the cone axis KA, in particular of 8 degrees. It can be seen that the conical taper 24 is longer in the direction of the cone axis KA than the conical widening 25. The conical taper 24 extends as far as the free end E of the end piece 30.

The cross-sectional constriction 23 has a cylindrical channel section 26 in the area of the smallest inner diameter D2. This is located between the conical taper 24 and the conical widening 25. The conical widening 25 is shorter in the direction of the cone axis KA than the cylindrical channel section 26. On the other hand, the conical taper 24 is longer in the direction of the cone axis KA than the cylindrical channel section 26.

Furthermore, the access channel 21 has a cylindrical end section 27 on the side facing the filter tube 10, which projects into the filter tube 10. As a result, in the area of the smallest inner diameter D2, the cross-sectional constriction 23 has a cross-sectional area A2 that is smaller than a cross-sectional area A1 of the cavity 11. In addition, the access channel 21 has a diameter D3 in the end piece 30 at the end facing the filter tube 10 that is smaller than the diameter D1 of the cavity 11.

The access channel 21 in the end piece 30 has a smaller diameter D3 at the end pointing towards the filter tube 10 than a diameter D4 at the free end E pointing away from the filter tube 10. This diameter D4 of the access channel 21 at the free end E is even larger than the internal diameter D1 of the cavity 11.

In the area of the access 20, a tube-shaped plug-in coupling section 31 is formed by the end piece 30, which forms an outer circumference 32 and the free end E, and is designed for axial insertion into a mounting opening 70 (see FIG. 3). The outer circumference 32 of the plug-in coupling section 31 has two sealing grooves 33, 34, in each of which a sealing ring 60, 61 is seated.

In particular, the plug-in coupling section 31 has a parallel outer wall 35 in front of, between and behind the sealing grooves 33, 34. At the free end E, the plug-in coupling section 31 has an insertion slope 38. The other end of the plug-in coupling section 31 has an insertion stop 37 in the form of a surrounding rib.

FIG. 3 shows a detailed view of an end piece 30 of a filter element 1 in a mounting opening 70. The end piece 30 corresponds at least essentially to that of FIG. 2. Identical components therefore have the same reference number and reference is first made to the description of FIG. 2. In FIG. 2, however, unlike in FIG. 3, it cannot be seen or is not included that at least two radial passage openings 36 are formed in the plug-in coupling section 31. According to FIG. 3, these are arranged in two axially offset planes which lie between the sealing grooves 33, 34 and each of which connects a radial environment around the outer circumference 32 with the access channel 21. The end piece 30 sits in the mounting opening 70 in such a way that a mounting gap 71 remains between the two sealing rings 60, 61, the outer circumference 32 and the mounting opening 70.

The pressure gradient in the access channel 21, which is designed as a Venturi tube 22, and the offset in the direction of axis A generate a continuous flushing flow S between the two axially offset passage openings 36, which keeps the mounting gap 71 clean. It can be seen that in the present case at least six such radial passage openings 36 are formed in the plug-in coupling section 31, which are arranged in the two axially offset planes and each of which connects a radial environment around the outer circumference 32 to the access channel 21 in pairs. The radical passage openings 36 are arranged equally distributed over a circumference of the plug-in coupling section 31.

It can be seen that a cross-sectional area of the relevant passage opening 36 is substantially smaller than the smallest cross-sectional area A2 of the cross-sectional constriction 23 of the venturi tube 22. More preferably, the passage openings 36 have a cross-sectional area of at most one percent of the smallest cross-sectional area A2 of the cross-sectional constriction 23.

FIG. 4 shows a filter module 50 with a filter housing 51, which forms a housing cavity 52 with a filter inlet 53 and a filter outlet 54. The side opposite the filter inlet 53 and filter outlet 54 has a service cover. A fluid sump 55 for a separated fluid is formed in the lower area of the housing cavity 52.

As an example, two filter elements 1 are arranged in the housing cavity 52, which can correspond to those in FIGS. 1 to 3. Through a manifold, which can accommodate even more of these filter elements 1, the filter inlet 53 opens into the access opening (20) of the filter element 1 arranged further down, through which the air flows from the inside to the outside. In order to separate a fluid, for example, the filter tube (10) of this filter element 1 would have to be coalescing.

The filter outlet 54 flows via another distributor, which can also feed a plurality of filter elements 1, into the access opening 20 of the filter element 1 arranged further upwards. The fluid from the housing cavity 52 flows through the filter tube (10) from the outside inwards to the filter outlet 54. In order to separate a fluid, for example, the filter tube (10) of this filter element 1 would have to be designed as a separator.

If, for example, a fuel contaminated with water were to be passed through the filter module 50, the information would coalesce in the lower filter element 1 and drip off. The coalesced water droplets sink into the fluid sump 55. Finely dissolved residual quantities of water in the fuel are then retained on the upper filter element 1, designed as a separator, and drip off it. The separated water droplets then also sink past the lower filter element 1 to the fluid sump 55.

The invention is not limited to one of the embodiments described above, but can be modified in a variety of ways.

Thus, the access channel 21 or the end piece 30 could also be formed in one piece with at least one layer of the filter tube 10, then preferably with the optional support tube 14.

All features and advantages resulting from the claims, the specification and the drawing, including design details, spatial arrangements and process steps, can be essential to the invention both individually and in a wide variety of combinations.

### BEZUGSZEICHENLISTE

1 Filter element
10 Filter tube
11 Hollow
12 first end
13 second end
14 Support tube
15 Filter material
16 Filter material
17 Potting compound
20 Access opening
21 Access channel
22 Venturi tube
23 Cross-section narrowing
24 Conical tapering
25 Conical widening
26 Cylindrical duct section
27 Cylindrical end section
30 End piece
31 Plug-in coupling section
32 Outer circumference
33 Sealing groove
34 Sealing groove
35 Cylindrical outer wall
36 radiale Durchtrittsöffnung
37 Einsteckanschlag
38 Einführschräge
39 Aufnahmenut
40 Locking piece
41 Recording groove
42 Casting compound
50 Filter module
51 Filter housing
52 Housing cavity
53 Filter inlet
54 Filter drain
55 Fluid sump
60 Sealing ring
61 Sealing ring
70 Mounting opening
71 Mounting gap
A Achse
Axis
A1 Cross-sectional area (cavity)
A2 Cross-sectional area (cross-sectional constriction)
D1 Diameter (cavity)
D2 Diameter (cross-sectional constriction)
D3 Diameter
D4 Diameter (free end)
E free end
KA Cone axis
L Length (cavity)
S Flushing flow

1. Filter element (1) with a filter tube (10) which has a cavity (11) and a first and a second end (12, 13), an access (20) into the cavity (11) with an access channel (21) being constructed at the first end (12) of the filter tube (10), characterized in that the access channel (21) is constructed as a Venturi tube (22) with a narrowed cross-section (23).

2. Filter element (1) according to claim 1, characterized in that
the cross-sectional constriction (23) comprises a conical taper (24) in the direction of the cavity (11); and/or
the cross-sectional constriction (23) has a conical widening (25) in the shape of a cone in the direction of the cavity (11).

3. Filter element (1) according to claim 1. characterized in that the access channel (21) comprises a cylindrical end section (27) on the side facing the filter tube (10).

4. Filter element (1) according to claim 1. characterized in that the cavity (11) has a length (L) between the first and second ends (12, 13) which is at least four times as great as a width of the cavity (11) in the transverse direction thereto.

5. Filter element (1) according to claim 1. characterized in that the access channel (21) takes the form of an end piece (30) which is connected to the filter tube (10).

6. Filter element (1) according to claim 5, characterized in that the access channel (21) in the end piece (30) has a diameter (D3) at the end pointing towards the filter tube (10) which is smaller than a diameter (D4) at the end pointing away from the filter tube (10).

7. Filter element (1) according to claim 5. characterized in that the end piece (30) has a receiving groove (39) on the side facing the filter tube (10), into which groove the filter tube (10) is axially inserted.

8. Filter element (1) according to claim 1. characterized in that the filter tube (10) has a layered structure with a support tube (14) and at least one filter material (15, 16).

9. Filter element (1) according to claim 1. characterized in that a tubular plug-in coupling section (31) with an outer circumference (32) as well as a free end (E) for axial insertion into a mounting opening (70) is formed in the region of the access (20), at least two radial passage openings (36) being formed in the plug-in coupling section (31), which are arranged in at least two planes axially offset from one another and which each communicate a radial environment around the outer circumference (32) with the access channel (21).

10. Filter element (1) in accordance with claim 9, characterized in that at least six radial passage openings (36) are formed in the plug-in coupling section (31), which are arranged in at least two planes axially offset from one another, and each of which connects a radial environment around the outer circumference (32) to the access channel (21).

11. Filter element (1) according to claim 9. characterized in that the radial passage openings (36) are distributed over a circumference of the plug-in coupling section (31).

12. Filter element (1) according to claim 9, and characterized in that one, two or at least two sealing grooves (33, 34) for one sealing ring (60, 61), respectively are formed in the outer circumference (32) of the plug-in coupling section (31), the through-openings (36) being arranged between the free end (E) of the plug-in coupling section (31) and that of the sealing grooves (36) which is arranged furthest away from the free end (E).

13. Filter element (1) in accordance with claim 9. characterized in that at least two sealing grooves (33, 34) are provided and the passage opening (36) is arranged between the two sealing grooves (33, 34).

14. Filter element (1) according to claim 9, and characterized in that a cross-sectional area of the respective passage opening (36) is smaller than one percent of the smallest cross-sectional area (A2) of the access channel (21) (22).

15. Filter module (50) with a filter housing (51), which forms a housing cavity (52) with a filter inlet (53) and a filter outlet (54), as well as with at least one filter element (1) according to claim 1 in the housing cavity (52), wherein the filter inlet (53) or the filter outlet (54) opens into the access opening (20) of the filter element (1) and is thereby flow-connected to the housing cavity (52) via a filter element (1).
